(19) United States
(12) Patent Application Publication
(10) Pub. No.: US 2002/0041330 A1
(43) Pub. Date: Apr. 11, 2002

(54) Electronic camera

(75) Inventors: Takeshi Uryu, Tokyo (JP); Masaaki Tsuchida, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA CORPORATION

(21) Appl. No.: 09/968,503

(22) Filed: Oct. 2, 2001

(30) Foreign Application Priority Data
Oct. 10, 2000 (JP) 309049/2000

(51) Int. Cl. H04N 5/228

(52) U.S. Cl. 348/233; 348/222

(57) ABSTRACT

An image pick-up apparatus comprises: a camera body; an image pick-up element which converts optical images into electric signals; a controller which controls the image pick-up element. The controller can either read or write data between a first memory and the controller and also between a second memory and the controller via a first common bus, and the camera body is structured so that the first memory can be removed therefrom and attached thereto. The image pick-up apparatus further comprises a sensor which detects that the first memory has been removed from the camera body and then outputs a detected signal.

### BACKGROUND OF THE INVENTION

The present invention relates to an image pick-up apparatus which is structured so that image data picked up by an image pick-up element is recorded in a memory medium

As electronics technology has progressed, an electronic camera which converts photographed images into digital data and stores the data has been developed and merchandised. Users of this camera, for example, can display images photographed by the electronic camera on their personal computers or print the images by means of a printer, which makes the camera widely applicable.

Incidentally, an electronic camera has been developed which stores program data in ROM and reads out the data from the ROM to RAM via a CPU only at the time when the program is executed to conduct an intended operation. Further, in certain types of CPUs, connections between ROM and a CPU and the CPU and a detachable recording medium, such as a memory card, are made via a common bus.

### SUMMARY OF THE INVENTION

In this kind of structure, if a recording medium is removed or inserted while program data is being read from ROM, noise occurs to the common bus, affecting the read program data, resulting in preventing the electronic camera from executing an intended operation.

To eliminate such a problem, it is recommended that a CPU be connected with ROM and also with a detachable recording medium, such as a memory card, via each exclusive line. However, it increases the cost arising a new problem.

Further, when an electronic camera has not been in use for a while after the camera was turned on, some electronic cameras enter a sleep mode to suppress the camera's power consumption. In such electronic cameras with a sleep mode function, techniques are required to quickly release the sleep mode while consuming little power.

In view of the foregoing, the main object of the present invention is to provide an electronic camera that maintains high reliability while suppressing the cost or can quickly release the sleep mode while consuming little power.

Preferable structures to attain the objects of the present invention are as follows.

(Structure 1) An image pick-up apparatus comprising: a camera body; an image pick-up element which converts optical images into electric signals; a controller which controls the image pick-up element, wherein the controller can either read or write data between a first memory and the controller and also between a second memory and the controller via a first common bus, and the camera body is structured so that the first memory can be removed therefrom and attached thereto; and a sensor which detects that the first memory has been removed from the camera body and then outputs a detected signal.

(Structure 2) The image pick-up apparatus according to Structure 1, wherein the controller does not read or write data between the second memory and the controller when the detected signal has been output.

(Structure 3) The image pick-up apparatus according to Structure 1, wherein the controller stops reading or writing data between the second memory and the controller when the detected signal has been output.

(Structure 4) The image pick-up apparatus according to Structure 1 further comprising means for inhibiting data reading or writing between the controller and the second memory when the detected signal is output while data is being read or written between the controller and the second memory.

(Structure 5) The image pick-up apparatus according to any one of Structures 1 through 4, wherein the second memory is a program data storage memory.

(Structure 6) The image pick-up apparatus according to Structure 5, wherein the second memory is a ROM.

(Structure 7) The image pick-up apparatus according to Structure 5, wherein the second memory is a flush memory.

(Structure 8) The image pick-up apparatus according to any one of Structures 1 through 4, wherein the second memory is a image data storage memory.

(Structure 9) The image pick-up apparatus according to Structure 8, wherein the second memory is a flush memory.

(Structure 10) The image pick-up apparatus according to any one of Structures 1 through 9, wherein the camera body comprises a storage chamber to store the first memory and a lid to cover at least a part of the storage chamber, and the sensor detects that the lid has been opened.

(Structure 11) The image pick-up apparatus according to Structure 4, wherein the inhibiting means stops supplying power to the controller when the detected signal is output while the controller is reading or writing data between the second memory and the controller.

(Structure 12) An image pick-up apparatus comprising: a camera main body; an image sensor for converting an optical image into electrical signals; a controller for controlling the image sensor, wherein the controller is capable of at least one of reading data and writing data between a first memory and the controller and between a second memory and the controller through a first common bus, and the first memory is detachably attachable to the camera main body; and an inhibitor for inhibiting at least one of attaching and detaching the first memory while the reading data or writing data is conducted between the second memory and the controller.

(Structure 13) The image pick-up apparatus according to Structure 12, wherein the second memory is a program data storage memory, and the inhibiting means inhibits at least one of the removal and insertion of the first memory while the controller is reading out program data from the second memory and writing the data into a third memory which is connected via a second bus which is different from the first bus.

(Structure 14) The image pick-up apparatus according to Structure 13, wherein it is inhibited to read out the program data from the second memory until the power to the controller is turned off after the program data has been once read out from the second memory and written into the third memory.

(Structure 15) The image pick-up apparatus according to any one of Structures 1 through 14 further comprising alarm means for generating an alarm while data is being exchanged between the second memory and the controller.

(Structure 16) The image pick-up apparatus according to any one of Structures 1 through 15, wherein the image pick-up apparatus is a digital still camera.

(Structure 17) The image pick-up apparatus according to Structure 12, further comprising: a sensor for detecting that the first memory is detached from the camera main body, and for outputting a detected signal.

(Structure 18) The image pick-up apparatus according to Structure 2, wherein when the detected signal is outputted while the reading data or writing data is conducted between the second memory and the controller, supply of electrical power to the controller is stopped and the controller does not read or write data between the second memory and the controller.

(Structure 19) An electronic camera having a CPU which can set a sleep mode that reduces power consumption of the CPU, wherein RAM which stores startup program data for releasing the sleep mode is separately arranged from RAM which stores other program data.

(Structure 20) An electronic camera having a CPU which can set a sleep mode that reduces power consumption of the CPU, wherein RAM which stores startup program data for releasing the sleep mode is built in the CPU.

(Structure 21) An image pick-up apparatus comprising: a camera body; an image pick-up element which converts optical images into electric signals; a controller which controls the image pick-up element, wherein the controller can either read or write data between a first memory and the controller and also between a second memory and the controller via a first common bus, and the camera body is structured so that the first memory can be removed therefrom and attached thereto; a sensor which detects that the first memory has been removed from the camera body and then outputs a detected signal; and a CPU which can set a sleep mode that reduces power consumption of the CPU, wherein RAM which stores startup program data for releasing the sleep mode is separately arranged from RAM which stores other program data.

(Structure 22) An image pick-up apparatus comprising: a camera body; an image pick-up element which converts optical images into electric signals; a controller which controls the image pick-up element, wherein the controller can either read or write data between a first memory and the controller and also between a second memory and the controller via a first common bus, and the camera body is structured so that the first memory can be removed therefrom and attached thereto; a sensor which detects that the first memory has been removed from the camera body and then outputs a detected signal; and a CPU which can set a sleep mode that reduces power consumption of the CPU, wherein RAM which stores startup program data for releasing the sleep mode is built in the CPU.

(Structure 23) An image pick-up apparatus comprising: a camera body; an image pick-up element which converts optical images into electric signals; and a controller which controls the image pick-up element, wherein the controller can either read or write data between a plurality of the memories and the controller, and startup program data for releasing a sleep mode is stored in a memory which consumes the least power among the plural memories.

Preferable structures of the present invention for attaining the object stated above are as follows.

(Structure 24) An electronic camera having a plurality of memory media at least one of which is removably mounted, wherein each memory medium mounted to the electronic camera is connected with a CPU via a common bus so that the data supply is possible, and the electronic camera further comprising control means for detecting that one of the memory media has been removed and then inhibiting the data supply between remaining memory media of the plurality of memory media and the CPU.

(Structure 25) The electronic camera according to Structure 22, wherein one of the remaining memory media is a program data storage ROM.

(Structure 26) The electronic camera according to Structure 25, wherein the ROM is a flush memory.

(Structure 27) The electronic camera according to any one of Structures 24 through 26, wherein one of the remaining memory media is a flush memory which stores image data.

(Structure 28) The electronic camera according to any one of Structures 24 through 27, wherein the control means employs a detecting device which detects that one of the memory media has been removed.

(Structure 29) The electronic camera according to any one of Structures 24 through 28, wherein the control means employs a detecting device which detects that a lid of a storage chamber which stores the removably-mounted memory has been opened.

(Structure 30) The electronic camera according to any one of Structures 24 through 29, wherein the control means detects that one of the memory media has been removed and then stops power supply to the CPU.

(Structure 31) An electronic camera comprising a program memory for storing program data, a removably-mounted data memory for storing image data and RAM, wherein the data memory and the program memory each mounted to the electronic camera are connected with a CPU via a common bus so that the data supply is possible and the RAM is connected with the CPU via a bus which is different from the bus connecting the program memory, and the electronic camera further comprising means for inhibiting the removal or insertion of the program memory while program data is being read out from the program memory to the RAM via the CPU.

(Structure 32) The electronic camera according to Structure 31, wherein it is inhibited to read out program data from the program memory until the power to the CPU is turned off after the program data has once been read out from the program memory and written into the RAM via the CPU.

(Structure 33) The electronic camera according to Structure 31 or 32 further comprising alarm means for generating an alarm while data is being supplied between the program memory and the CPU.

(Structure 34) An electronic camera having a CPU which can set a sleep mode that reduces power consumption of the CPU, wherein RAM which stores startup program data for releasing the sleep mode is separately arranged from RAM which stores other program data.

(Structure 35) An electronic camera having a CPU which can set a sleep mode that reduces power consumption of the CPU, wherein RAM which stores startup program data for releasing the sleep mode is built in the CPU.

The first image pick-up apparatus according to the present invention comprises a camera body, an image pick-up element which converts optical images into electric signals, and a controller which controls the image pick-up element, wherein the controller can either read or write data between a first memory and the controller and also between a second memory and the controller via a first common bus, and the camera body is structured so that the first memory can be removed therefrom and attached thereto. The image pick-up apparatus has a sensor which detects that the first memory has been removed from the camera body and then outputs a detected signal.

Therefore, even though noise may occur when the first memory is removed or inserted, it is possible to perform the control, by detecting that the first memory has been removed or inserted, so as to prevent the noise from occurring or prevent the noise from affecting the supplied data.

Further, in an electronic camera with a plurality of memory media at least one of which is removably mounted, each memory mounted to the electronic camera is connected to a CPU via a common bus so that the data supply is possible. If the image pick-up apparatus employs control means for detecting that one of the memory media has been removed and then inhibiting the data supply between the remaining the memory and the CPU, even though noise may occur when one of the first memory media is removed or inserted, it is possible to perform the control to prevent the noise from affecting the supplied data by inhibiting data supply between the remaining the memory and the CPU.

Further, in an electronic camera comprising a program memory for storing program data, a removably-mounted data memory for storing image data and RAM, the data memory and the program memory each mounted to the electronic camera are connected to a CPU via a common bus so that the data supply is possible, and the RAM is connected to the CPU via a bus which is different from the bus connecting the program memory. If the electronic camera employs means for inhibiting the removal or insertion of the program memory while program data is being read out from the program memory to the RAM via the CPU, even though noise may occur when the program memory is removed or inserted, it is possible to prevent the noise from affecting the data by inhibiting the removal or insertion of the program memory while data is being supplied between the program memory and the CPU.

Further, the second image pick-up apparatus according to the present invention comprises an electronic camera having a CPU which can set a sleep mode that reduces power consumption of the CPU, wherein RAM which stores startup program data for releasing the sleep mode is separately arranged from RAM which stores other program data. Accordingly, power consumption of the CPU can be reduced more than when power is continuously supplied to SDRAM which stores all operational programs during a sleep mode so as to quickly start operation.

Further, the third image pick-up apparatus according to the present invention comprises an electronic camera having a CPU which can set a sleep mode that reduces power consumption of the CPU, wherein RAM which stores startup program data for releasing the sleep mode is built in the CPU. Accordingly, power consumption by the CPU can be reduced more than when power is continuously supplied to SDRAM which stores all operational programs during a sleep mode so as to quickly start operation.

### BRIEF DESCRIPTION OF THE DRAWINGS

FIG. 1 is a block diagram that illustrates the structure of an electronic camera which is an embodiment of the present invention.

FIG. 2 is a flow chart that shows operations of an electronic camera.

### DETAILED DESCRIPTION OF THE PREFERRED EMBODIMENTS

Preferred embodiments of the present invention will be detailed below referring to the drawings.

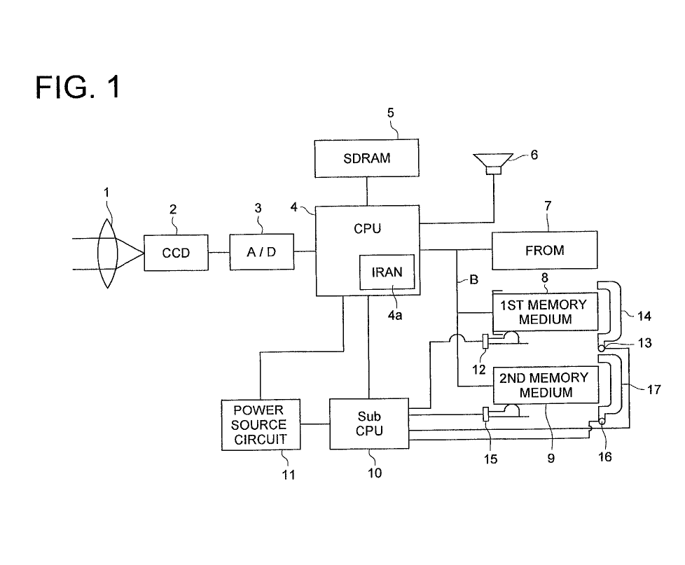

FIG. 1 is a block diagram that illustrates the structure of an electronic camera of this embodiment. In FIG. 1, power is supplied to a CPU 4 from a power source circuit 11 and the CPU which controls each portion is connected to FROM (Flash ROM) 7 which is a program memory, a first memory 8 which is a data memory such as a compact flush memory removably-mounted to a camera body, and a second memory 9 which is a data memory such as smart media removably-mounted to a camera body via a common bus B. A storage chamber (not shown) of the first memory 8 has a first sensor 12 which is a device for detecting that the first memory 8 has been either inserted to or removed from the storage chamber and a second sensor 13 which is a device for detecting that a lid 14 of the storage chamber has been opened, and is structured to output signals to a Sub-CPU 10. Similarly, a storage chamber (not shown) of a second memory 9 has a third sensor 15 which is a device for detecting that the second memory 9 has been either inserted to or removed from the storage chamber and a fourth sensor 16 which is a device for detecting that a lid 17 of the storage chamber has been opened, and is structured to output signals to the Sub-CPU 10. The CPU 4 is connected to the Sub-CPU 10, SDRAM 5 and a speaker 6, which is alarm means, via each separate bus which is different from the bus B.

When a release switch (not shown) is pressed, the CPU 4 starts photographing, CCD 2, wherein an image of an object picked up by a photographing lens 1 is formed on the light-receiving surface, outputs analog image signals according to the light intensity, and then an A/D converter 3 converts the signals into digital image data.

After being processed, the converted image data is stored in a first memory 8 or a second memory 9.

In this embodiment, program data is stored in FROM 7, resulting in poor accessibility. It is not efficient to read out the data to the CPU 4 every time when the program is executed. Therefore, highly accessible SDRAM 5 is separately installed so that the program data is stored in the SDRAM 5 from the FROM 7 via the CPU 4 and then read out to the CPU 4 to execute the program when necessary.

In this embodiment, the CPU 4 is connected to the FROM 7, the first memory 8 and the second memory 9 via a common bus B. Accordingly, for example, if the first memory 8 is removed or inserted while program data is being read out from the FROM 7, noise occurs which affects the data and prevents the program from being executed. To eliminate such a problem, this embodiment takes measures as follows.

When a power source switch (not shown) is turned on, the CPU 4 reads out program data from the FROM 7 and stores the data in the SDRAM 5. At this point, when the second sensor 13 detects the lid 14 has been opened, or the first sensor 12 detects the first memory 8 has been removed or inserted, a detected signal is sent to a Sub-CPU 10. In response to this, the Sub-CPU 10 stops power supply to the CPU 4. Then, it becomes impossible for the CPU 4 to read out the program data from the FROM 7, resulting in preventing noise from affecting the program data to be stored in the SDRAM 5.

Further, a preferable structure is: when the first sensor 12 detects the first memory 8 being inserted or the second sensor 13 detects the lid 14 being closed, power supply to the CPU 4 restarts and the CPU 4 restarts reading out program data from the FROM 7. Such a structure makes it possible for the program data to be quickly read without being affected by noise.

Incidentally, this embodiment performs the control to prevent data supply between the CPU 4 and the FROM 7 by stopping power supply to the CPU, however, it is also possible to prevent the data supply by controlling the CPU 4 to stop reading out data from the FROM 7.

Furthermore, in this embodiment, an explanation has been given about performing the control to refrain the data supply between the CPU 4 and the FROM 7 by detecting the first memory 8 has been removed or inserted. Similarly, as to the second memory 9, the control is performed to refrain the data supply between the CPU 4 and the FROM 7 in response to a detected signal sent to the Sub-CPU 10 from the third sensor 15 or the fourth sensor 16.

Incidentally, as described above, an explanation has been given about the control performed while the CPU 4 is reading out program data from other memory connected to a common bus B together with a memory removably-mounted to a camera body. It is preferable to perform the same control while the CPU 4 is exchanging image data with other memory connected to a common bus B together with a memory removably-mounted to a camera body.

Specifically, the control is performed to stop writing image data into the first memory 8 when the lid 17 is opened or the second memory 9 is removed while the CPU 4 is writing image data into the first memory 8. This makes it possible to refrain image data which contains noise from being written into the first memory 8.

Further, when the lid 17 is opened or the second memory 9 is removed while the CPU 4 is reading out image data from the first memory 8 in order to display the image corresponding to the image data stored in the first memory 8 on the liquid crystal display (not shown) mounted on the camera body, the control is performed to stop reading out image data from the first memory 8. This makes it possible to refrain a poorly visible image which contains noise from being displayed.

It is also possible to place the second memory 9 on the substrate and use it as a built-in memory (NAND FLASH and so on) for storing image data. In this case, similarly to the above, the Sub-CPU 10 stops power supply to the CPU 4 in response to a detected signal sent to the Sub-CPU 10 when the second sensor 13 detects the lid 14 being opened or the first sensor 12 detects the first memory 8 being removed or inserted so that the CPU 4 cannot read out data from the second memory 9. As a result, it is possible to prevent noise caused by the removal of the first memory 8 from affecting the data which is read out from the second memory 9.

As another example of a first embodiment, it is possible to employ means for inhibiting the removal or insertion of a first memory 8 or a second memory 9 while program data is being read from FROM 7 to SDRAM 7 via a CPU 4. This inhibiting means, for example, can be a locking member which locks a lid 14 and a lid 17 preventing them from being open or a locking mechanism which fastens a first memory 8 and a second memory 9 preventing them from being removed, but is not limited to those. Even though noise may occur when a first memory 8 or a second memory 9 is removed or inserted, employing such inhibiting means inhibits the removal or insertion of the first memory 8 and the second memory 9 while data is being supplied between the FROM 7 and the CPU 4, resulting in suppressing the effect of noise. This altered example can be applied to the case where image data is exchanged between the first memory 8 and the CPU 4 to prevent noise from affecting the image data.

Furthermore, it is possible to reread a program after the program has been once read from the FROM 7 to the SDRAM 7 via the CPU 4 before power is turned off, however, it is preferable to read the program only once after the power has been turned on. This makes it possible to eliminate the process of rereading program data after the program data has been once read out from the FROM 7. Accordingly, even though the control is not performed to stop the data supply between the CPU 4 and the FROM 7 when a first memory 8 or a second memory 9 is removed or inserted, it is possible to prevent generated noise from affecting the program data. Consequently, problems, such as a malfunction of the camera, can be prevented.

Further, it is preferable that users be alerted that the first memory 8 cannot be removed or inserted if a speaker 6 is employed as alarm means to generate an alarm while data is being supplied between the FROM 7 and the CPU 4.

Other alarms besides a speaker can be applied, such as display means (not shown) including a liquid crystal display mounted on the camera body which displays an alarm message or alarm symbol or an LED (not shown) which lights an LED lamp mounted on the camera.

Incidentally, electronic cameras enter a sleep mode after a certain time elapses from the last operation to minimize power consumption so as to save energy. At this point, power consumption by SDRAM 7 is relatively large and there is a need to suppress the power consumption during a sleep mode. Here, the sleep mode implies a mode in which the reduction of consumed electric power is conducted by operating only a part of CPU through, for example, stopping the supply of clock to each portion inside CPU. However, if the clock supply to the SDRAM 7 is stopped, a restart becomes impossible. Therefore, a second embodiment of the present invention described below employs IRAM 4a in a CPU 4 to store startup program so that a quick restart is possible even when the clock supply to the SDRAM 7 during a sleep mode is stopped.

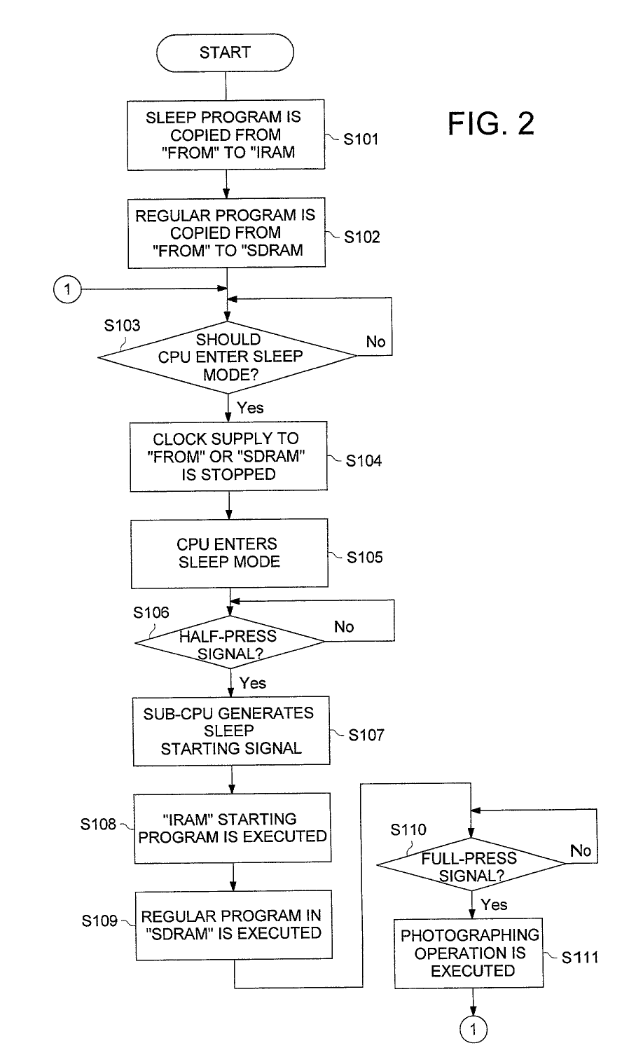

Now, the second embodiment will be described with reference to a drawing. FIG. 2 is a flow chart that shows operations of an electronic camera of this embodiment. In Step S101 in FIG. 2, a sleep program is read from FROM 7 to IRAM 4a in response to the power source switch (not shown) being turned on. Further, in Step S102, a regular operational program is read from the FROM 7 to the SDRAM 5.

Here, if the CPU 4 senses that now is the time to enter a sleep mode, for example, after a certain time elapses or for some other reasons (Step S103), the clock supply to the FROM 7 and the SDRAM 5 is stopped (Step S104) and the CPU 4 enters into a sleep mode (Step S105).

After that, when a half-press signal is output by a release button (not shown) being pressed halfway (Step S106), causing a Sub-CPU 10 to generate a sleep starting signal (Step S107), startup program stored in IRAM 4a is read out and executed (step S108), and then the clock supply to the SDRAM 7 restarts.

And then, photographing program stored in the SDRAM 7 is read out (Step S109), a full-press signal is output by a release button being fully pressed (Step S110), and in response to that, a photographing operation is executed (Step S111). After that, an electronic camera will enter into a sleep mode when necessary.

As described above, this embodiment employs IRAM 4a which stores program data, and the startup program is executed based on the startup program data by means of a given operation of the electronic camera, such as pressing a release button. Consequently, power consumption can be reduced during a sleep mode more than when power is continuously supplied to SDRAM 7 which stores all operational program data so as to quickly start the system. Further, it is possible to restrain a noise adding to the program by storing the program to the RAM.

As stated above, while preferred embodiments of the present invention have been explained, the present invention is not meant to be limited to the above embodiments and alterations can be made when necessary.

The present invention makes it possible to provide an electronic camera that maintains high reliability while reducing the cost or quickly releases a sleep mode while consuming little power.

What is claimed is:

1. An image pick-up apparatus comprising:
(a) a camera main body;
(b) an image sensor for converting an optical image into electrical signals;
(c) a controller for controlling the image sensor, wherein the controller is capable of at least one of reading data and writing data between a first memory and the controller and between a second memory and the controller through a first common bus, and the first memory is detachably attachable to the camera main body; and
(d) a sensor for detecting that the first memory is detached from the camera main body, and for outputting a detected signal.

2. The image pick-up apparatus of claim 1, wherein when the detected signal is outputted, the controller does not read or write data between the second memory and the controller.

3. The image pick-up apparatus of claim 1, wherein when the detected signal is outputted, the controller stop reading data or writing data between the second memory and the controller.

4. The image pick-up apparatus of claim 1, further comprising an inhibitor for inhibiting the reading data or the writing data between the second memory and the controller, when the detected signal is outputted while the reading data or writing data is conducted between the second memory and the controller.

5. The image pick-up apparatus of claim 1, wherein the second memory is a memory for storing program data.

6. The image pick-up apparatus of claim 5, wherein the second memory is a read only memory (ROM).

7. The image pick-up apparatus of claim 5, wherein the second memory is a flush memory.

8. The image pick-up apparatus of claim 1, wherein the second memory is a memory for storing image data.

9. The image pick-up apparatus of claim 8, wherein the second memory is a flush memory.

10. The image pick-up apparatus of claim 1, wherein the camera main body comprises a cover for covering a housing chamber for housing the first memory and at least a part of the housing chamber, the sensor detects that the cover is opened.

11. The image pick-up apparatus of claim 4, wherein when the detected signal is outputted while the reading data or writing data is conducted between the second memory and the controller, the inhibitor stops supply of electric power to the controller.

12. An image pick-up apparatus comprising:
(a) a camera main body;
(b) an image sensor for converting an optical image into electrical signals;
(c) a controller for controlling the image sensor, wherein the controller is capable of at least one of reading data and writing data between a first memory and the controller and between a second memory and the controller through a first common bus, and the first memory is detachably attachable to the camera main body; and
(d) an inhibitor for inhibiting at least one of attaching and detaching the first memory while the reading data or writing data is conducted between the second memory and the controller.

13. The image pick-up apparatus of claim 12, wherein the second memory is a memory for storing program data, the attaching and detaching inhibitor inhibits at least one of attaching and detaching the first memory while the controller reads the program data from the second memory and writes the program data to a third memory connected through a second bus different from the first bus.

14. The image pick-up apparatus of claim 13, wherein after once the program data are read from the second memory and written into the third memory, the program data are inhibited from being read from the second memory until supply of electric power to the controller is stopped.

15. The image pick-up apparatus of claim 12, further comprising a warning device for giving a warning while data are communicated between the second memory and the controller.

16. The image pick-up apparatus of claim 1, wherein the image pick-up apparatus is a digital still camera.

17. The image pick-up apparatus of claim 12, further comprising:
a sensor for detecting that the first memory is detached from the camera main body, and for outputting a detected signal.

18. The image pick-up apparatus of claim 2, wherein when the detected signal is outputted while the reading data or writing data is conducted between the second memory and the controller, supply of electrical power to the controller is stopped and the controller does not read or write data between the second memory and the controller.
